(19) United States
(12) Patent Application Publication
(10) Pub. No.: US 2014/0156703 A1
(43) Pub. Date: Jun. 5, 2014

(54) METHOD AND APPARATUS FOR TRANSLATING GRAPHICAL SYMBOLS INTO QUERY KEYWORDS

(71) Applicant: Altera Corporation, (US)

(72) Inventors: Khan Seng Teong, Gelugor (MY); Denis Chuan Hu Goh, Gelugor (MY)

(73) Assignee: Altera Corporation, San Jose, CA (US)

(21) Appl. No.: 13/691,288

(22) Filed: Nov. 30, 2012

(51) Int. Cl. G06F 17/30

(52) U.S. Cl. CPC G06F 17/30979
USPC 707/772

(57) ABSTRACT

Computer equipment operable to translate a graphical symbol into keywords is disclosed. The computer equipment includes a database of keywords. An input analyzer tool may be used to retrieve a list of keywords from the database based on the graphical symbol. The input analyzer tool may be implemented using processing circuitry that accepts graphical input and performs symbol translation to formulate a search query related to the graphical input. An information search may be performed with the formulated search query using a search engine.

### BACKGROUND

Generally, a search engine may receive a query and may perform a search based on the query. Depending on the input requirements of the search engine, queries in various formats such as text, images, audio streams, etc., may be accepted.

The result of each search performed by the search engine may depend on the accuracy of the query received. As an example, a user may input a string of keywords to search for desired information. However, query keywords using broad terminology may return too many results. For example, if the user is searching for information related to a specific integrated circuit using broad keywords such as “embedded pins” or “rectangular housing,” without specifying any particular integrated circuit, the returned results may include irrelevant information. Consequently, the user may end up spending unnecessary time refining the query keywords in order to obtain a more relevant result.

As another example, the user may opt for content-based information search by using an image as a query input. However, content-based information searches may only return images as search result, instead of a list of document links (e.g., web pages, directory), because content-based information search is performed by interpreting the input image based on what the human eye can perceive, such as colors or texture of the image.

### SUMMARY

Embodiments of the present invention include computing equipment capable of translating a graphical symbol using its underlying properties into query keywords.

It is appreciated that the present invention can be implemented in numerous ways, such as a process, an apparatus, a system, a device, or a method on a computer readable medium. Several inventive embodiments of the present invention are described below.

A method for using computing equipment having a display, processing circuitry, and storage is provided. The method includes providing a user with an on-screen opportunity to select a graphical symbol from a plurality of graphical symbols for searching. The on-screen opportunity may be presented using the display. The processing circuitry may retrieve a list of keywords corresponding to the selected graphical symbol from the storage. The processing circuitry may also perform an information search using a search engine based on the retrieved list of keywords to obtain search results.

Computing equipment for searching information using a graphical input is provided. The computing equipment includes storage circuitry configured to store a database of keywords and an input analyzer tool operable to retrieve a list of keywords from the database based on the graphical input. If desired, the database may be stored remotely (e.g., at network 63) and retrieved using processing circuitry. The computing equipment also includes processing circuitry operable to implement the input analyzer, accept the graphical input and return a search result based on the formulated search query. The search query may be generated from the list of keywords retrieved from the database.

A method of searching for information related to a collection (set) of graphical symbols selected by a user is also provided. The method includes, with a display, providing the user with an on-screen opportunity to select a graphical symbol from the collection of graphical symbols for searching. Processing circuitry retrieves a list of keywords related to the collection of graphical symbols from a storage element. The processing circuitry also formulates a search query to retrieve information related to the collection of graphical symbols using a search engine. In other words, the search query may be generated from the list of keywords that corresponds to the set of graphical symbols.

Further features of the invention, its nature and various advantages, will be more apparent from the accompanying drawings and the following detailed description of the preferred embodiments.

### BRIEF DESCRIPTION OF THE DRAWINGS

FIG. 1 is a block diagram of illustrative computing equipment that may be used to implement computer-based software tools in accordance with an embodiment of the present invention.

FIG. 2 is a diagram of an illustrative integrated circuit in accordance with an embodiment of the present invention.

FIG. 3 is a table showing a set of attributes and associated keywords of a graphical symbol in accordance with an embodiment of the present invention.

FIG. 4 is a diagram of an illustrative computer-implemented software tool in accordance with an embodiment of the present invention.

FIG. 5 is a diagram of an illustrative input analyzer tool in accordance with an embodiment of the present invention.

FIG. 6 is a table showing an illustrative set of rules and associated keywords that may be used to characterize a collection of graphical symbols in accordance with an embodiment of the present invention.

FIG. 7 is an illustrative design editor tool for modifying information related to a collection of graphical symbols in accordance with an embodiment of the present invention.

FIG. 8 is a flow chart of illustrative steps for translating a graphical symbol into search query in accordance with an embodiment of the present invention.

FIG. 9 is a flow chart of illustrative steps for using computing equipment to search for information related to a collection of graphical symbols in accordance with an embodiment of the present invention.

### DETAILED DESCRIPTION

The embodiments provided herein include systems and techniques of translating graphical symbols into query keywords.

It will be obvious, however, to one skilled in the art that the present exemplary embodiments may be practiced without some or all of these specific details. In other instances, well-known operations have not been described in detail in order not to unnecessarily obscure the present embodiments.

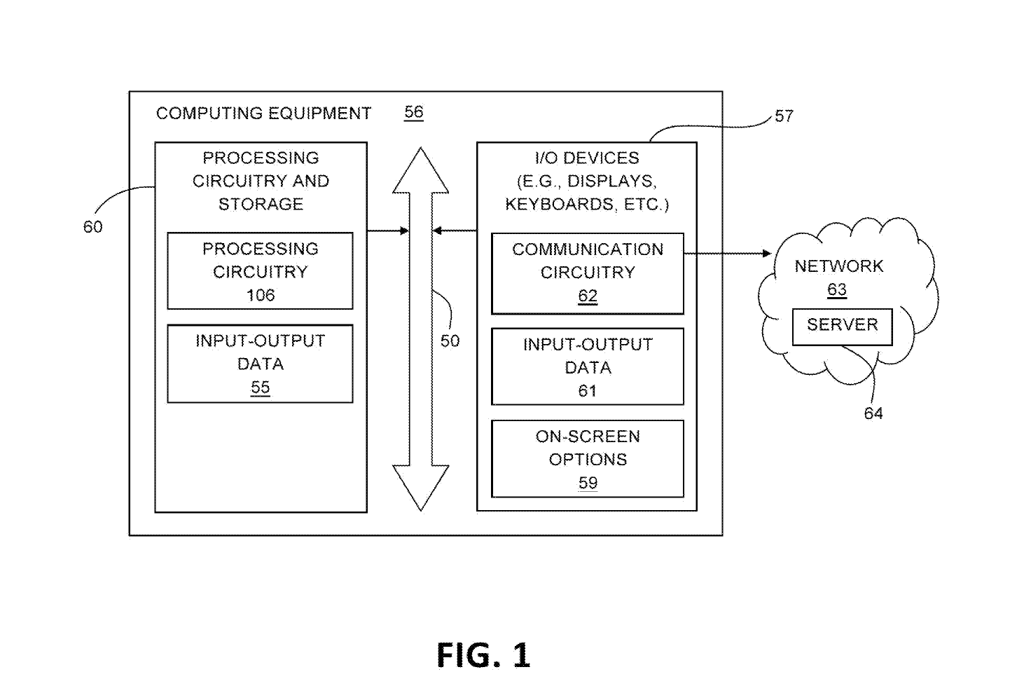

FIG. 1 is a diagram of illustrative computing equipment 56 in accordance with an embodiment of the present invention. Computing equipment 56 may include processing circuitry and storage 60. Computing equipment 56 may be based on one or more processors such as personal computers, workstations, etc. Processing circuitry 106 may include circuitry for performing various supported instructions. Storage in circuitry 60 may be organized to form shared and stand-alone databases. The stored information in the storage of processing circuitry and storage 60 may include input and output data 55. For example, input data may include settings selected by a user or a software library. Output data may include modeling results, configuration data, reports and any other suitable processed output from computing equipment 56.

In supporting design operations involved in implementing a desired custom logic function, computing equipment 56 may use software that runs on storage and processing circuitry 106. This software may take the form of one or more programs. When the programs are running on computing equipment 56, computing equipment 56 is sometimes referred to as a computer-aided design tool (or tools).

Input-output devices 57 may include input devices such as pointing devices and keyboards and may include output devices such as printers and displays. As shown in FIG. 1, computing equipment 56 may display on-screen options 59 on a display. The user may click on these on-screen options or may otherwise make selections based on the displayed information. The user may also provide input by typing into text boxes, by performing drag and drop operations, using tabs, etc. Input-output data 61 may be displayed on a display or printed for a user. Input-output data 61 may include input data (e.g., data that a user has typed into a text-box or has selected using a drop-down menu or other selectable options) and output data (e.g., modeling results, reports, information indicative of design choices, etc.).

Communication circuitry 62 may facilitate data and information exchange between various circuits of computing equipment 56 through bus interface circuitry 50. As an example, communication circuitry 62 may provide various protocol functionality (e.g., Transmission Control Protocol/Internet Protocol (TCP/IP) (including the physical layer, or PHY), User Datagram Protocol (UDP) etc.), as desired. As another example, communication circuitry 62 may communicate with network 63 (e.g., Ethernet, token ring, etc.). Network 63 may include one or more servers 64 that store data and information. If desired, communication circuitry 62 may be used to send and receive data from server 64 over network 63.

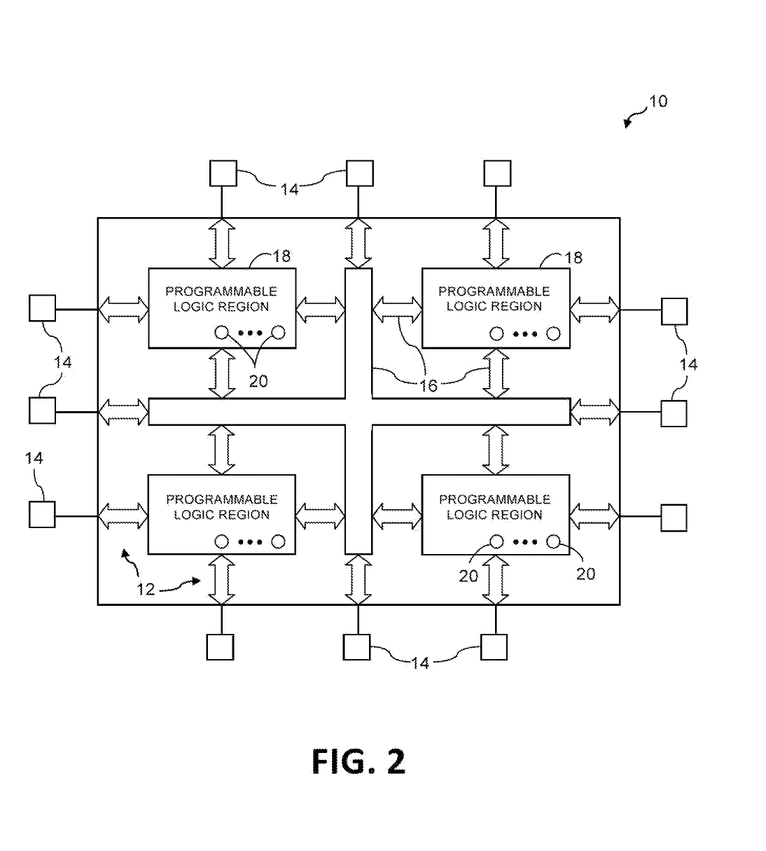

FIG. 2 is a diagram of an illustrative integrated circuit 10 that may be configured using computing equipment in accordance with an embodiment of the present invention. Programmable integrated circuit 10 may have input/output circuitry 12 for driving signals off of integrated circuit 10 and for receiving signals from other circuits or devices via input/output pins 14. Interconnection resources 16 such as global and local vertical and horizontal conductive lines and busses may be used to route signals on device 10. Interconnection resources 16 include fixed interconnects (conductive lines) and programmable interconnects (e.g., programmable connections between respective fixed interconnects). Programmable logic 18 may include combinational and sequential logic circuitry. The programmable logic 18 may be configured using computing equipment such as computing equipment 56 of FIG. 1 to perform a custom logic function. The programmable interconnects associated with interconnection resources 16 may be considered to be a part of programmable logic 18.

A typical memory element 20 is formed from a number of transistors configured to form cross-coupled inverters. For example, complementary metal-oxide-semiconductor (CMOS) integrated circuit technology may be used to form memory elements 20 with one suitable approach. In the context of programmable logic device integrated circuits, the memory elements store configuration data and are therefore sometimes referred to as configuration random-access memory (CRAM) cells.

Memory elements 20 are generally arranged in an array pattern. In a programmable logic device, there may be millions of memory elements 20 on each chip. A user (e.g., a logic designer) may provide configuration data for the array of memory elements during programming operation. Once loaded with configuration data, memory elements 20 may selectively control (e.g., turn on and off) portions of the circuitry in programmable logic region 18 and thereby customize its functions as desired.

When memory elements 20 are arranged in an array, horizontal and vertical conductors and associated control circuitry may be used to access the memory elements 20. The control circuitry may, for example, be used to clear all or some of the memory elements. The control circuitry may also write data to the memory elements 20 and may read data from the memory elements 20. For example, in CRAM arrays, memory elements 20 may be loaded with configuration data. The loaded configuration data may then be read out from the memory array to confirm proper data capture before device 10 is used during normal operation in a system.

The circuitry of programmable logic device 10 may be organized using any suitable architecture. For instance, programmable logic regions 18 may be organized in a series of rows and columns of larger programmable logic regions each of which contains multiple smaller regions. The larger regions are sometimes referred to as logic array blocks. The smaller logic regions are sometimes referred to as logic elements. A typical logic element may contain a look-up table, registers, and programmable multiplexers. If desired, programmable logic regions 18 may be arranged in more levels or layers in which multiple large regions are interconnected to form still larger portions of logic.

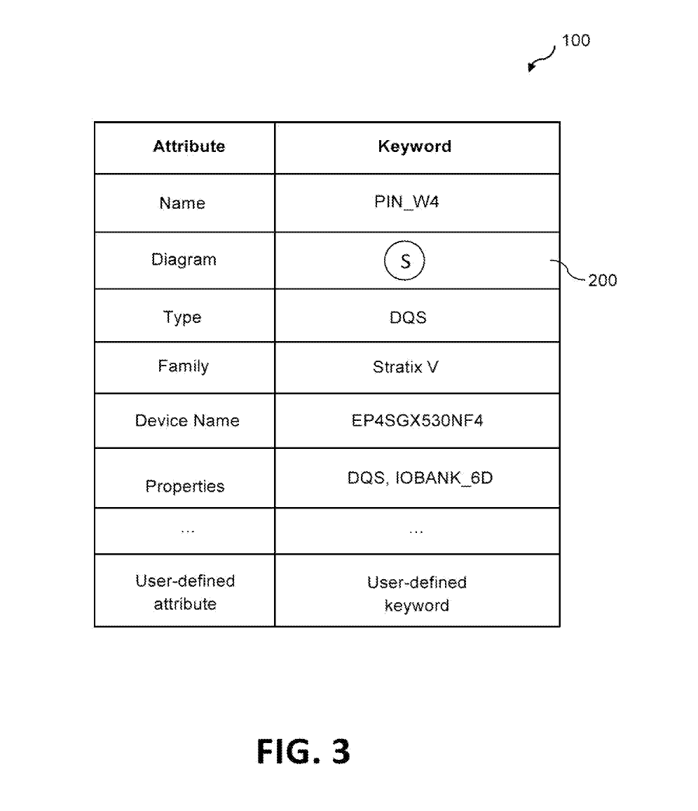

During logic design operations, computing equipment 56 may present a graphical interface using input-ouput devices such as a display. The graphical interface may include graphical symbols that represent corresponding circuits and/or functions to be implemented. A logic designer may select one or more graphical symbols using the graphical interface when implementing a custom user design. Computing equipment 56 may retrieve a set of attributes for a selected graphical symbol (e.g., from a database). Search queries may be generated from keywords that are associated with the retrieved set of attributes. A table showing a set of attributes and associated keywords of an illustrative graphical symbol 200 in accordance with an embodiment of the present invention is depicted in FIG. 3.

In the example of FIG. 3, symbol 200 is a graphical representation of a device pin of an integrated circuit (e.g., the integrated circuit 10 of FIG. 2). Symbol 200 may be associated with a set of attributes such as name, type, family name, device name, properties that may describe the characteristics of symbol 200, etc.

From the exemplary data shown in FIG. 3, it may be readily understood by a person skilled in the art that symbol 200 may be a data strobe pin that may interface with an external memory of an integrated circuit (e.g., integrated circuit 10 of FIG. 2) based on the symbol type (e.g., data strobe DQS). As an example, symbol 200 may be referred as “PIN_W4”. Symbol 200 may be available on certain devices which may be represented in a specific naming format. For example, symbol 200 may be associated to an integrated device with device name called “EP4SGX530NF4513”. The table below shows the description of each part in device name “EP4SGX530NF4513”.

| Part Name | Description |
|---|---|
| EP4SGX | Type of device (e.g., Stratix IV) |
| 530 | Pin count (e.g., 530 pins) |
| N | Feature of device |
| F45 | Package size of the device |
| I | Temperature range for the device |
| | package |
| 3 | Speed grades |

In one embodiment, symbol 200 may have properties that may characterize the functionality of symbol 200. As shown in FIG. 3, symbol 200 may function as a strobe pin (e.g., DQS), an I/O bank (e.g., IOBANK_{—}6D), and etc. In another embodiment, symbol 200 may be associated with user-defined attributes and keywords.

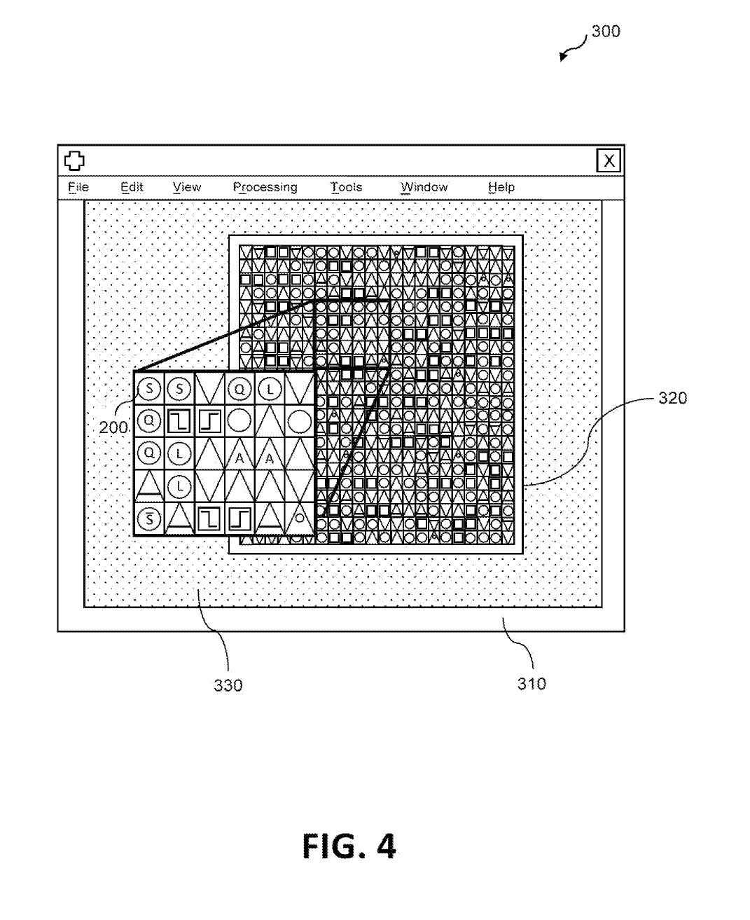

FIG. 4 is a diagram of illustrative computer-implemented software tools 300 that may be presented using a display in accordance with an embodiment of the present invention. Computer-implemented software tools 300 may be implemented on computing equipment 56 of FIG. 1. Computer-implemented software tools 300 may include computer-aided design tools. In the example of FIG. 4, computer-implemented software tools 300 may be a pin planner tool that may provide a graphical representation of pins (e.g., symbol 200 of FIG. 3) on an integrated circuit device, such as integrated circuit 10 of FIG. 2.

Computer-implemented software tools 300 may be presented using a display (e.g., display 310). Available graphical symbols may be presented in region 320 of display 310. The displayed symbols may include a device pin symbol (e.g., symbol 200) may be presented in region 320. Computer-implemented software tools 300 may also allow a user (e.g., a logic designer) to provide graphical symbol(s) to be presented on display 310. For example, the plurality of symbols may be imported from a software library.

A logic designer may select one or more graphical symbols (e.g., symbol 200) from the available graphical symbols as a graphical input for information searching. Accordingly, the user may place the graphical input in active area 330 by dragging and dropping the graphical input from region 320. In one embodiment, active area 330 may be part of a query interface that may accept dragging and dropping of the graphical input via an input device (e.g., a mouse).

When the user drags and drops the graphical input into active area 330 or otherwise selects a graphical input for processing, processing circuitry 106 of FIG. 1 may retrieve the corresponding attributes of the graphical input (e.g., attributes of a device pin). Subsequently, processing circuitry 106 may perform a matching operation to match the attributes of the graphical input to a set of design rules to retrieve a list of keywords associated with the graphical input from a storage element (e.g., storage in circuitry 60 of FIG. 1). An input analyzer tool may serve to process a selected graphical input to identify a corresponding list of keywords.

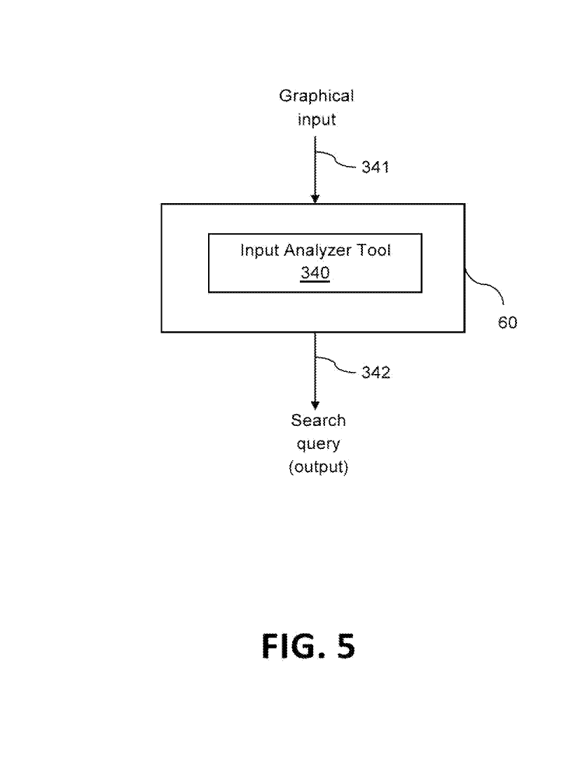

FIG. 5 is a diagram of an illustrative input analyzer tool 340 implemented in processing circuitry and storage 60 of FIG. 1. Input analyzer tool 340 may be implemented as a part of computer-implemented software tools 300 of FIG. 4 or may be implemented separately.

Input analyzer tool 340 may receive graphical input 341. Graphical input 341 may include one or more graphical symbols. For example, graphical input 341 may include a collection of graphical symbols. As another example, graphical input 341 may include graphical symbols selected from region 320 of FIG. 4 by a user.

If desired, input analyzer tool 340 may interpret the received graphical input 341 based on a set of design rules. Input analyzer tool 340 may translate graphical input 341 into a meaningful information, by performing a matching operation to match graphical input 341 with the set of design rules from a storage element (e.g., storage in circuitry 60 of FIG. 1). If a match is found, input analyzer tool may retrieve equivalent keywords that are associated with the matching design rules. Consequently, the retrieved keywords may be used as a search query to retrieve information relevant to graphical input 341 using a search engine. For example, input analyzer tool 340 may form search query 342 from the retrieve keywords (e.g., the retrieved keywords may serve as query keywords).

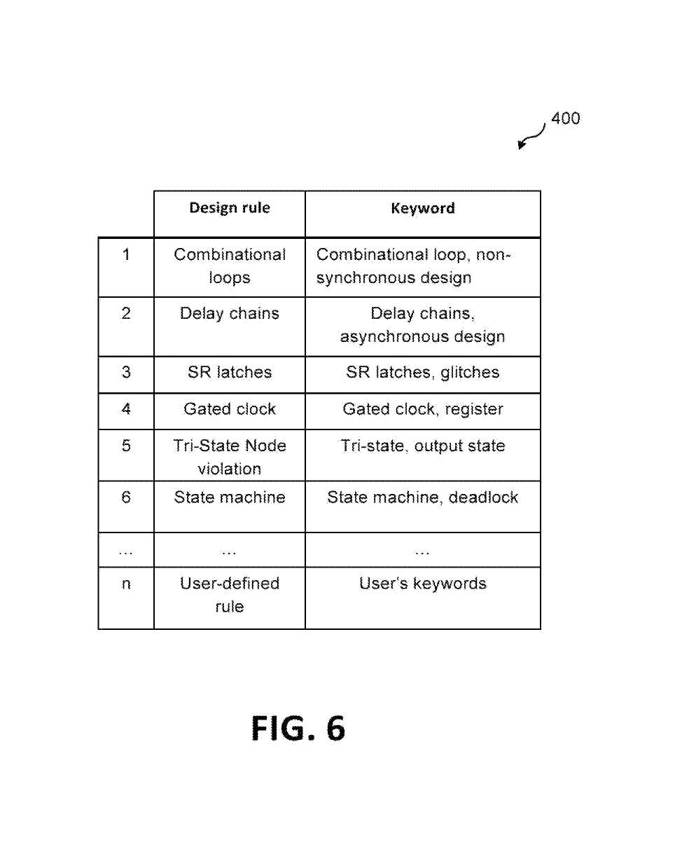

FIG. 6 is a table showing an illustrative set of design rules and associated keywords that can be used to characterize graphical symbols in accordance to the present invention. In one embodiment, when a “combinational loops” rule is matched with the attributes that define the collection of graphical symbols as combinational loops, keywords such as “combinational loop” and “non-synchronous design” may be retrieved from storage. The retrieved keywords may be used to form a search query to retrieve information related to the collection of graphical symbols from a storage element (e.g., the Internet) using a search engine.

As another example, a pair of cross-coupled NOR gates may be presented on display 310 of FIG. 4 as a collection of interconnected graphical symbols. The pair of cross-coupled NOR gates may form a Set-Reset (SR) latch. A user may select the collection of graphical symbols as an input. As shown in database table 400, the “SR latches” rule may apply to that collection of symbols through the matching operation. Accordingly, processing circuitry 106 of FIG. 1 may identify that the collection of symbols represents a Set-Reset (SR) latch, which matches the design rule “SR latches.” Processing circuitry 106 may subsequently retrieve keywords such as “SR latches” and “glitches” from storage to form a query. The query may be used to retrieve information related to the collection of symbols using a search engine.

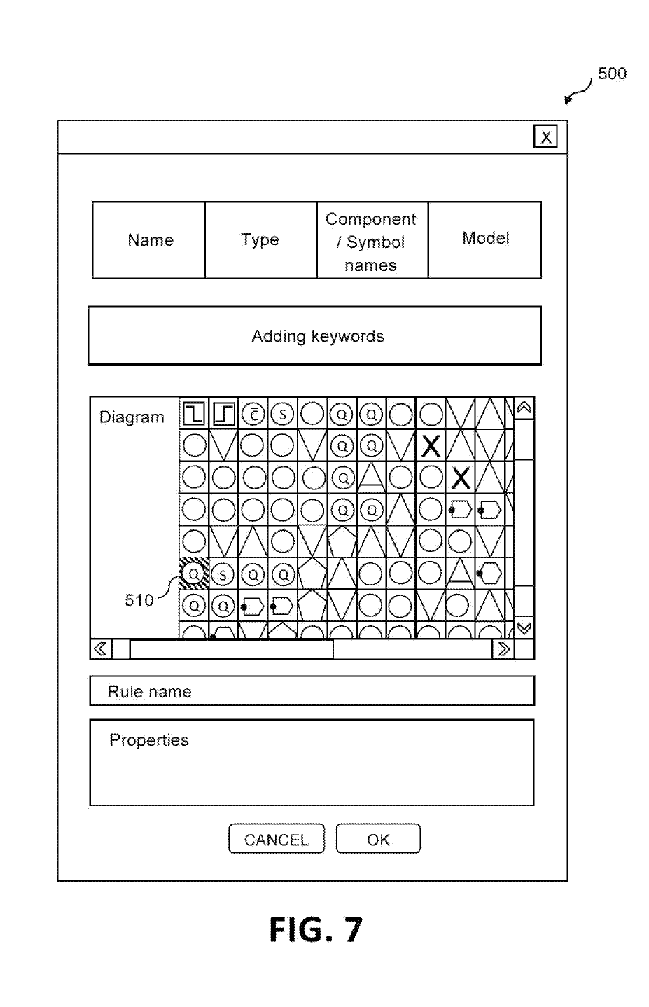

If desired, the user may have the option of refining the keywords for corresponding graphical symbols. FIG. 7 is an illustrative design editor tool 500 for modifying information related to the graphical symbol in accordance with one embodiment of the present invention. Design editor 500 may be used to edit the attributes (e.g., name, type, component/symbol, model, etc.) of a graphical symbol (e.g., symbol 510). If desired, the user may provide user-defined keywords to define the graphical symbol by selecting the “adding keywords” input. If a collection of graphical symbols is selected, the user may enter a suitable rule name and properties that may describe the characteristics of the collection of graphical symbols (e.g., a user may define design rules such as shown in FIG. 6 using design editor 500).

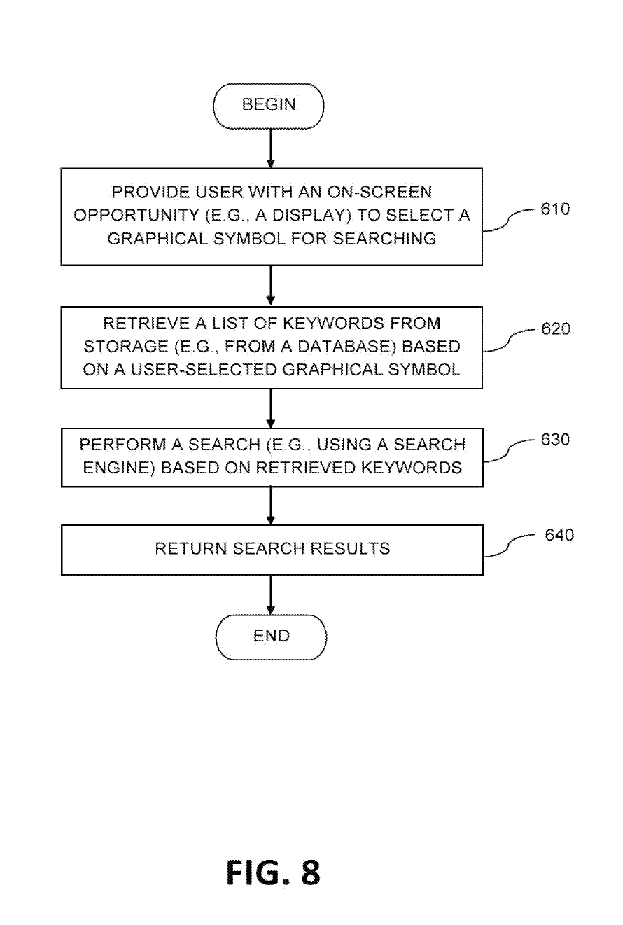

FIG. 8 shows illustrative steps involved in translating a graphical symbol into a search query. At step 610, a user is provided with an on-screen opportunity (e.g., using a display) to select a graphical symbol for searching. For example, tools 300 of FIG. 4 may allow the user to select a graphical symbol (e.g., symbol 200 of FIGS. 2 and 3) from region 320 shown in display 310. In one embodiment, the graphical symbol may be selected from a collection of graphical symbols that may be implemented automatically by tools 300 or may be imported from a software library, if desired. The example of FIG. 8 in which a single graphical symbol is processed is merely illustrative. If desired, multiple graphical symbols may selected and processed to form a search query from corresponding keywords (e.g., the keywords of multiple graphical symbols may be combined).

At step 620, a list of keywords is retrieved from storage (e.g., from a database) based on a user-selected graphical symbol. For example, processing circuitry 106 of FIG. 1 may access the attributes of device pin 200 of FIG. 3 in order to retrieve a list of keywords from storage. By using a search engine, an information search may be performed at step 630 based on the retrieved keywords. In one embodiment, processing circuitry 106 may generate a query based on the retrieved keywords for the search engine. Accordingly, search results are returned from the search engine in response to the search query at step 640. In one embodiment, the search result may include documents or document links, figures, etc.

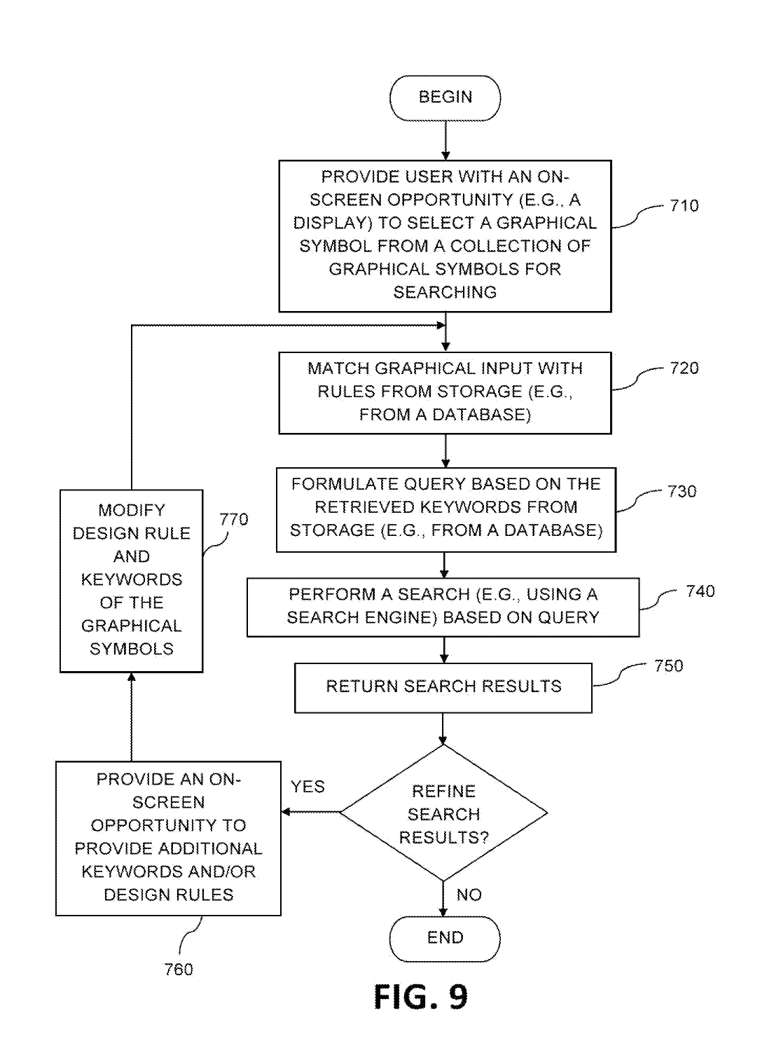

FIG. 9 shows illustrative steps involved in searching for information related to a collection of graphical symbols using computing equipment 56 of FIG. 1. At step 710, a user is provided with an on-screen opportunity to select a graphical symbol from a collection of graphical symbols for searching. For example, tools 300 may provide the user with a query interface that may receive the selected graphical symbol as an input. In the embodiment of FIG. 4, tools 300 may provide an active area (e.g., active area 330) that may be used to place the graphical input.

At step 720, the graphical input may be matched with design rules from storage. Processing circuitry 106 of FIG. 1 may interpret the graphical symbol using the attributes of the graphical symbol which may include visual descriptions of the graphical symbol. When a match is found, processing circuitry 106 may retrieve a list of keywords and a query may be formulated based on the retrieved keywords from storage at step 730. As an example, a query that may be formulated based on the retrieved keywords of symbol 200 of FIG. 3 is “StratixV EP4SGX530NF4513 PIN_W4 DQS, IOBANK_{—}6D, DQS5R, DFFIO_RX_R8p, DFFOUT_RX_R16P.”

The formulated query may then be used to retrieve information using a search engine at step 740. As an example, the search engine may include a web browser, a directory, etc. At step 750, search results are returned by the search engine with a list of information related with the query. The list of information may include documents or document links, and their respective descriptions and figures, if available.

At step 760, the user may be given the opportunity to refine the search results. If the user wishes to refine the search results, an on-screen opportunity may be provided to allow the user to input additional keywords and/or design rules at step 770. In one embodiment, processing circuitry 106 of FIG. 1 may display a design editor (such as design editor 500 of FIG. 7) for the user to modify the attributes of the selected graphical symbol.

Although the method operations were described in a specific order, it should be understood that other operations may be performed in between the described operations, the described operations may be adjusted so that they occur at different times or the described operations may be distributed in a system which allows the occurrence of the processing operations at various intervals associated with the processing, as long as the processing of the overlay operations are performed in a desired way.

The foregoing is merely illustrative of the principles of this invention and various modifications can be made by those skilled in the art without departing from the scope and spirit of the invention.

What is claimed is:

1. A method for using computing equipment having a display, processing circuitry, and storage, the method comprising:
with the display, providing a user with an on-screen opportunity to select a graphical symbol from a plurality of graphical symbols for searching;
with the processing circuitry, retrieving a list of keywords related to the selected graphical symbol from the storage; and
with the processing circuitry, performing an information search using a search engine based on the retrieved list of keywords to obtain search results.

2. The method defined in claim 1 wherein retrieving the list of keywords from the storage comprises retrieving the list of keywords from a database in the storage.

3. The method defined in claim 1 wherein providing the user with the on-screen opportunity to select the graphical symbol for searching, the method further comprising:
with a display, providing the user with a query interface that accepts the selected graphical symbol; and
with the query interface, providing an active area to place the selected graphical symbol.

4. The method defined in claim 1 further comprising:
with the processing circuitry, identifying attributes of the graphical symbol; and
with the processing circuitry, matching the attributes of the graphical symbol to a set of design rules retrieved from the storage.

5. The method defined in claim 4 wherein identifying attributes of the graphical symbol with the set of design rules comprises:
with the processing circuitry, retrieving attributes of the graphical symbol from storage, wherein the attributes include visual descriptions of the graphical symbol.

6. The method defined in claim 5 wherein retrieving attributes of the graphical symbol further comprises:
with the storage and processing circuitry, matching the underlying properties of the graphical symbol to the set of design rules to retrieve the list of keywords wherein each design rule is assigned a corresponding list of keywords in the database.

7. The method defined in claim 1 wherein retrieving the list of keywords from the storage further comprising:
with the processing circuitry, generating a search query from the list of keywords; and
with the processing circuitry, providing the search query to the search engine.

8. The method defined in claim 1, wherein the computing equipment is further configured to implement the storage and processing circuitry in a computer-aided design tool.

9. The method defined in claim 7 further comprising:
with the processing circuitry, providing the search query to a server via a network.

10. Computing equipment for searching information using a graphical input, comprising:
storage circuitry configured to store a database of keywords;
an input analyzer tool that retrieves a list of keywords from the database based on the graphical input; and
a processing circuitry that implements the input analyzer tool, accepts the graphical input and returns a search result based on a search query, wherein the search query is generated from the list of keywords retrieved from the database.

11. The computer equipment defined in claim 10, wherein the computing equipment further comprises:
a display configured to present an active area for placing the graphical input.

12. The computer equipment defined in claim 11 wherein a plurality of symbols are presented in a region on the display, wherein the computing equipment includes an input device that receives user input for dragging and dropping a selected symbol from the region on the display to the active area.

13. The computer equipment defined in claim 10 wherein at least one of the keywords is associated to at least one design rule of the graphical symbol.

14. The computer equipment defined in claim 10 wherein the graphical symbol is characterized by a set of design rules in the storage circuitry.

15. A method of searching for information related to a collection of graphical symbols selected by a user, the method comprising:
with a display, providing the user with an on-screen opportunity to select a graphical symbol from the collection of graphical symbols for searching;
with processing circuitry, retrieving a list of keywords related to the collection of graphical symbols from a storage;
with processing circuitry, formulating a search query from the list of retrieved keywords to search information related to the collection of graphical symbols; and
with the display, providing the user with an on-screen opportunity to customize the database.

16. The method defined in claim 15 further comprising:
with the display, providing the user with a query interface that accepts dragging and dropping of the selected graphical symbol via an input device; and
with the display, providing an active area to place the selected graphical symbol.

17. The method defined in claim 15 further comprising:
with the processing circuitry, retrieving attributes of the collection of graphical symbols wherein the attributes include visual descriptions of the symbol; and
with the processing circuitry, matching the attributes of the collection of graphical symbols to a set of design rules to retrieve the list of keywords from the storage.

18. The method defined in claim 15 further comprising:
with the processing circuitry, retrieving attributes of each symbol of the collection of graphical symbols; and
with the processing circuitry, matching the attributes of each symbol of the collection of graphical symbols to a set of design rules to retrieve the list of keywords from the storage.

19. The method defined in claim 15 wherein customizing the database comprises:
with the processing circuitry, modifying the list of retrieved keywords in the database.

20. The method defined in claim 19 further comprising:
with the processing circuitry, adding additional keywords to the list of retrieved keywords in the database.
